(19) United States
(12) Patent Application Publication
(10) Pub. No.: US 2015/0330827 A1
(43) Pub. Date: Nov. 19, 2015

(54) LEVEL SENSOR ASSEMBLY

(71) Applicant: Caterpillar Inc., Peoria, IL (US)

(72) Inventors: Christopher J. Robbins, Peoria, IL (US); Timothy G. Sidles, Oswego, IL (US)

(73) Assignee: Caterpillar Inc., Peoria, IL (US)

(21) Appl. No.: 14/813,151

(22) Filed: Jul. 30, 2015

(51) Int. Cl. G01F 23/34

(52) U.S. Cl. CPC G01F 23/34

(57) ABSTRACT

A level sensor assembly is provided. The level sensor assembly includes a first housing and a second housing. The first and second housings are coupled to define an internal chamber therewithin. The level sensor assembly includes an arm carrier assembly coupled to a first surface of the first housing. The level sensor assembly further includes a contact carrier assembly having a main body unit extending vertically within the internal chamber. The level sensor assembly includes a coupling mechanism provided at an interface of the arm carrier assembly and the contact carrier assembly. The contact carrier assembly also includes a resistor card element coupled to the second housing.

### TECHNICAL FIELD

The present disclosure relates to a level sensor assembly, and more particularly to the level sensor assembly for detecting a level of a liquid in an operating environment.

### BACKGROUND

Level sensors, such as fuel level sensors, are configured to determine a level of fuel within a tank. The level sensors generally include electrical elements, such as electrical wiper contacts and a conductive ink provided on a ceramic card. These electrical elements are sensitive to debris and may get damaged when exposed to debris. The level sensors are generally mounted within the tank. In operation, the level sensors come in contact with the fuel in the tank. The fuel sometimes contains foreign particles, such as dust, grime, dirt, and the like.

The contact of such foreign particles with the electrical elements of the level sensor may cause failure of the electrical elements. Further, some level sensors have wiper contacts that are directly coupled to a float wire with no decoupling. Such an arrangement may lead to early wear of the wiper contacts due to high frequency low amplitude float movements caused by fuel slosh.

U.S. Pat. No. describes a U.S. Pat. No. 5,462,622, hereinafter referred as the '622 patent describes a method of molding an electrical element within an associated plastic housing so as to provide a one-piece finished component where the electrical element, joints between the electrical element and the housing, and seams between a premold portion and an overmold portion of the plastic housing are designed and positioned for shielding from ambient atmosphere. However, the '622 patent does not describe a sensor assembly that protects the electrical elements from foreign particles.

### SUMMARY OF THE DISCLOSURE

In one aspect of the present disclosure, a level sensor assembly is provided. The level sensor assembly includes a first housing and a second housing. The second housing cooperates with the first housing. The first and second housings are coupled to define an internal chamber therewithin. The level sensor assembly also includes an arm carrier assembly coupled to a first surface of the first housing. The arm carrier assembly includes a channel provided on a first surface of the arm carrier assembly. The arm carrier assembly also includes a through hole. The channel and the through hole are arranged in a perpendicular relationship with each other. The channel and the through hole are configured to receive a float wire. The level sensor assembly further includes a contact carrier assembly having a main body unit extending vertically within the internal chamber. The contact carrier assembly includes electrical contacts. The contact carrier assembly is aligned with respect to the arm carrier assembly to receive the float wire. The level sensor assembly includes a coupling mechanism provided at an interface of the arm carrier assembly and the contact carrier assembly. The coupling mechanism is configured to prevent relatively small movements from translating in the level sensor assembly. The contact carrier assembly also includes a resistor card element coupled to the second housing. The resistor card element is in electrical communication with the contacts of the contact carrier assembly. A resistance associated with the resistor card element is configured to vary based on an angular position of the contact carrier assembly with respect to the resistor card element.

Other features and aspects of this disclosure will be apparent from the following description and the accompanying drawings.

### BRIEF DESCRIPTION OF THE DRAWINGS

FIG. 1 is a perspective view of an exemplary level sensor assembly, according to one embodiment of the present disclosure;

FIG. 2 is an exploded view of the level sensor assembly of FIG. 1, according to one embodiment of the present disclosure;

FIG. 3 is a perspective view of an arm carrier assembly of the level sensor assembly of FIG. 1, according to one embodiment of the present disclosure;

FIG. 4 is a perspective view of a contact carrier assembly of the level sensor assembly of FIG. 1, according to one embodiment of the present disclosure; and

FIG. 5 is a cross sectional view of an assembly of the arm carrier assembly of FIG. 3 and the contact carrier assembly, according to one embodiment of the present disclosure.

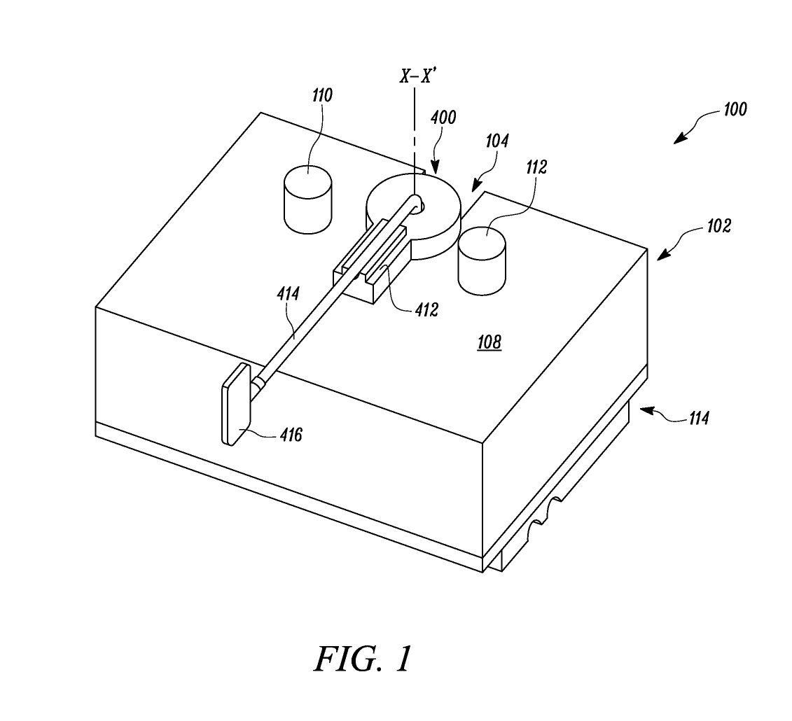

### DETAILED DESCRIPTION

Wherever possible, the same reference numbers will be used throughout the drawings to refer to the same or the like parts. FIG. 1 is a perspective view of an exemplary level sensor assembly 100, according to one embodiment of the present disclosure. The level sensor assembly 100 is configured to measure a level of a liquid stored within a storage means (not shown).

In one example, the level sensor assembly 100 is configured to measure fuel level present within a fuel tank (not shown) of an engine (not shown). The level sensor assembly 100 may be coupled with the fuel tank of any type of engine. For example, the engine equipped with the level sensor assembly 100 may include a compression ignition engine to combust a mixture of air and diesel fuel. In alternative embodiments, the engine may include any other type of engine that requires a fuel tank and a fuel level sensing means associated therewith. The engine may be configured for any suitable application such as motor vehicles, work machines, locomotives or marine engines, and in stationary applications such as electrical power generators. In another example, the level sensor assembly 100 may be associated with a reductant tank (not shown) of an exhaust aftertreatment system associated with the engine without any limitations. It should be noted that the teachings of the present disclosure can be extended to any application that demands the measuring of liquid level.

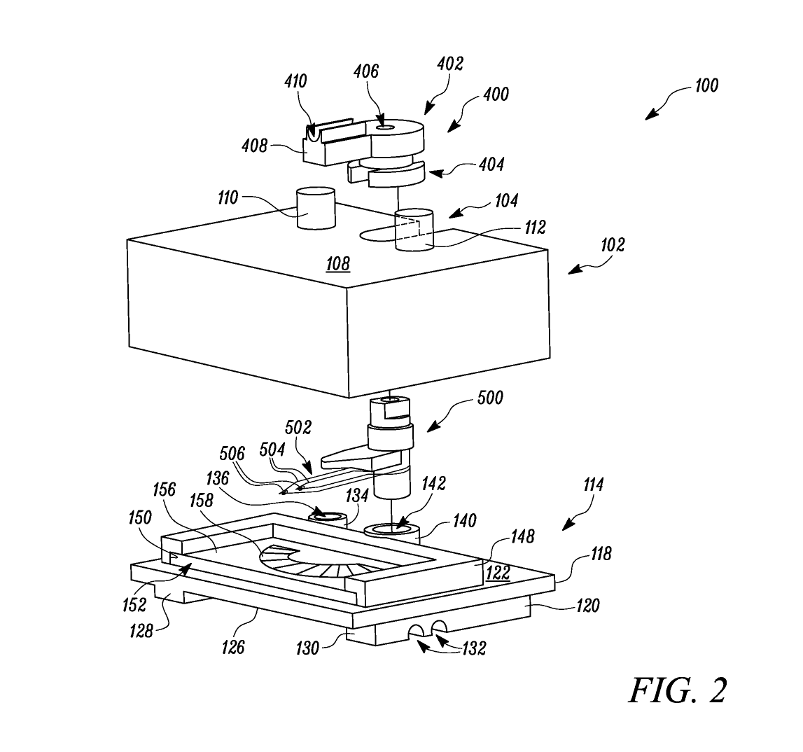

Referring to FIGS. 1 and 2, the level sensor assembly 100 includes a first housing 102. The first housing 102 is embodied as a substantially rectangular box. The first housing 102 includes a slot 104. The slot 104 has a U-shaped design. The slot 104 includes a groove (not shown) provided therein. The groove may have a U-shaped profile or a rectangular profile. Further, the first housing 102 includes one or more tabs projecting from an upper surface 108 of the first housing 102. As shown in the accompanying figures, the first housing 102 includes a first tab 110 and a second tab 112. The first and second tabs 110, 112 are configured to restrict any excessive movement of an arm carrier assembly 400 of the level sensor assembly 100 about a central axis X-X′.

Referring to FIG. 2, the level sensor assembly 100 includes a second housing 114. The second housing 114 cooperates with the first housing 102. When assembled, the first and second housings 102, 114 are coupled to define an internal chamber therewithin. The first and second housings 102, 114 are coupled to each other via a snap fit. A fit between the first and second housings 102, 114 is such that foreign particles, such as, dust, grime, dirt, are prevented from entering into the internal chamber. However, the fit allows a liquid to enter into the interior chamber for lubrication of moving components of the level sensor assembly 100. The liquid may enter through the interface between the first and second housings 102, 114.

The second housing 114 has a stepped design, having a first frame element 118 and a second frame element 120. When the level sensor assembly 100 is mounted on a work surface (not shown), a top surface 122 of the first frame element 118 is configured to be parallel with the work surface. In one example, the work surface may include a rectangular cut-out portion to receive the second housing 114 therein, such that the top surface 122 of the frame element 118 is configured to flush with the work surface. The top surface 122 of the frame element 118 receives and supports the first housing 102 thereon. The first frame element 118 includes an opening (not shown). The opening is substantially rectangular in shape.

Further, the second frame element 120 of the second housing 114 projects from a lower surface 126 of the first frame element 118. The second frame element 120 includes a pair of legs, namely a first leg 128 and a second leg 130. A pair of grooves 132 is provided on the second leg 130 of the second frame element 120. The grooves 132 are configured to receive wires (not shown) therein.

The second housing 114 includes a first projection 134. The first projection 134 includes an opening 136. The opening 136 is embodied as a through hole. The opening 136 is configured to receive a mechanical fastener (not shown) in order to removably couple the level sensor assembly 100 with the work surface. The mechanical fastener may include any one of a bolt, screw, pin, rivet, and the like. The work surface may include corresponding openings to receive the first projection 134.

The second housing 114 also includes a second projection 140. The second projection 140 includes an opening 142. The opening 142 is configured to receive a portion of a contact carrier assembly 500. The second housing 114 includes a C-shaped member 148. The C-shaped member 148 projects upwards from the top surface 122 of the second housing 114. The C-shaped member 148 includes a groove 150.

Referring to FIGS. 1, 2, and 3, the level sensor assembly 100 includes the arm carrier assembly 400. The arm carrier assembly 400 includes a first member 402 and a second member 404. The arm carrier assembly 400 is coupled to the first housing 102. More particularly, the second member 404 of the arm carrier assembly 400 is coupled to and received within the slot 104 of the first housing 102. The slot 104 vertically locks the arm carrier assembly 400 with the first housing 102.

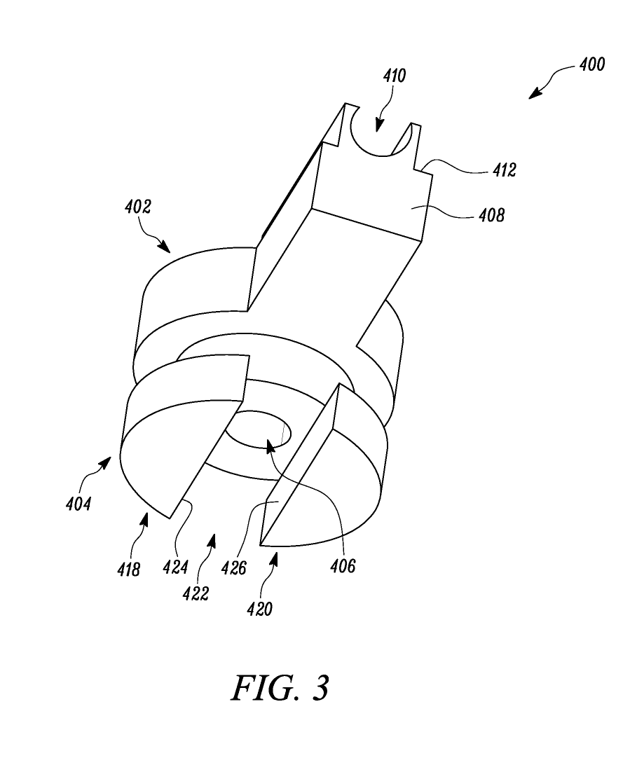

The first member 402 of the arm carrier assembly 400 is cylindrical in shape, and has a stepped design. The first member 402 includes a through hole 406 provided therein. The first member 402 includes a first arm 408 extending longitudinally from an upper portion of the first member 402. The first arm 408 includes a channel 410 provided on a first surface 412 (see FIGS. 1 and 3) of the arm carrier assembly 400. The channel 410 is provided such that the channel 410 and the through hole 406 are arranged in a perpendicular relationship with each other. The channel 410 and the through hole 406 of the arm carrier assembly 400 is configured to receive a float wire 414 therein. The arm carrier assembly 400 includes a snap retention feature that allows the float wire 414 to be vertically locked within the arm carrier assembly 400. The float wire 414 includes a float 416 provided at one end. The float 416 is configured to raise or lower within the tank based on a level of liquid within the tank.

As shown in FIG. 3, the second member 404 includes a first portion 418 and a second portion 420. The first and second portions 418, 420 are arcuate in shape. The first and second portions 418, 420 define a space 422 therebetween. A surface 424 of the first portion 418 faces a surface 426 of the second portion 420. Moreover, the surfaces 424, 426 of each of the first and second portions 418, 420 are parallel to each other.

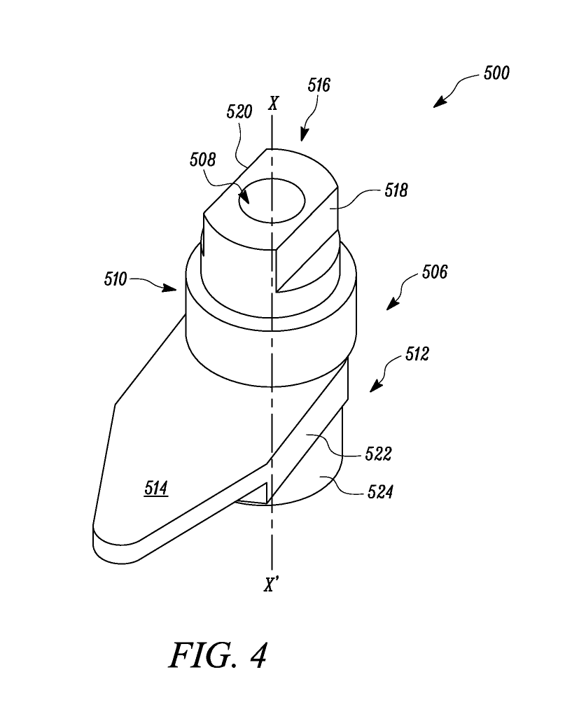

Referring to FIGS. 2 and 4, the level sensor assembly 100 includes the contact carrier assembly 500. The contact carrier assembly 500 includes electrical contacts 502 (see FIG. 2) coupled thereto. The electrical contacts 502 are grounded to earth. The electrical contacts 502 may include a pair of wipers 504 having contact surfaces 505 (see FIG. 2). The wipers 504 may be made of a metal.

The contact carrier assembly 500 includes a main body unit 506. The main body unit 506 extends vertically within the internal chamber. The main body unit 506 includes a through hole 508. During assembly of the level sensor assembly 100, the contact carrier assembly 500 is aligned with respect to the arm carrier assembly 400 to receive the float wire 414.

Referring to FIG. 4, the main body unit 506 includes a first portion 510 and a second portion 512. The first and second portions 510, 512 are separated by an arm member 514. The first portion 510 has a stepped design. The first portion 510 also includes an interface portion 516. The interface portion 516 includes a pair of parallel faces 518, 520. Further, the second portion 512 includes a rectangular member 522 and a circular member 524. The circular member 524 of the second portion 512 is received within the opening 142 of the second projection 140.

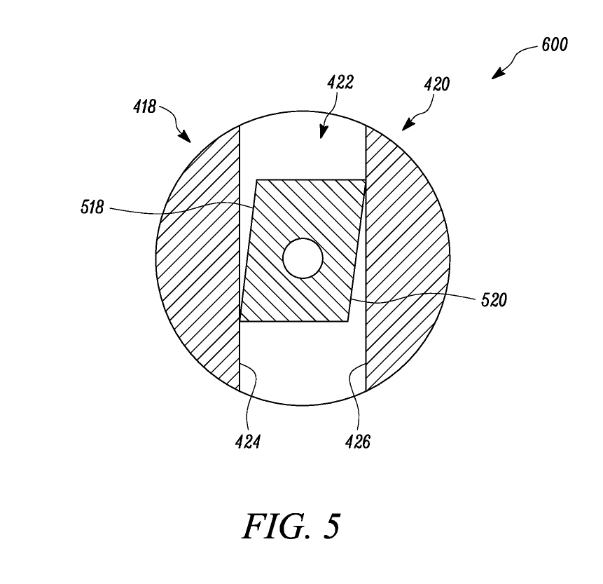

Referring to FIGS. 3, 4, and 5, the level sensor assembly 100 includes a coupling mechanism 600. The coupling mechanism 600 is provided at an interface of the arm carrier assembly 400 and the contact carrier assembly 500 (see FIG. 2). The coupling mechanism 600 is configured to couple the arm carrier assembly 400 and the contact carrier assembly 500. The coupling mechanism 600 is also configured to prevent relatively small movements of the float wire 414 to be translated in the level sensor assembly 100. The coupling mechanism 600 referred to herein is defined by the second portion 420 of the arm carrier assembly 400 and the interface portion 516 of the contact carrier assembly 500 (see FIGS. 3 and 4). The interface portion 516 is received within the space 422 defined in the second portion 420 of the arm carrier assembly 400. The dimensions of each of the interface portion 516 and the second portion 420 are decided such that a clearance is formed between the interface portion 516 and the second portion 420. The clearance allows a few degrees of play between the arm carrier assembly 400 and the contact carrier assembly 500.

As shown in FIG. 2, the level sensor assembly 100 also includes a resistor card element 152. The resistor card element 152 is coupled to the second housing 114. More particularly, the resistor card element 152 is provided and retained within the groove 150 of the C-shaped member 148. The resistor card element 152 is in electrical communication with the electrical contacts 502 of the contact carrier assembly 500, such that a resistance associated with the resistor card element 152 is configured to vary based on an angular position of the contact carrier assembly 500 with respect to the resistor card element 152.

The resistor card element 152 includes conductive ink 158 provided on a ceramic card 156 of the resistor card element 152. The conductive ink 158 may be provided in an arcuate shape. The electrical contacts 502 of the contact carrier assembly 500 are configured to move along the conductive ink 158. The conductive ink 158 is provided with an electrical connection through the wires. Vias (not shown) are formed within the ceramic card 156 that allow soldering of the wires to the conductive ink 158. Based on the movement of the electrical contacts 502, the resistance of the resistor card element 152 varies. The change in the resistance of the resistor card element 152 is measured in order to determine the level of the liquid within the tank.

Referring to FIGS. 1 and 2, as the float 416 raises or lowers within the tank, the float wire 414 rotates about the central axis X-X′ of the arm carrier assembly 400. The movement of the float wire 414 causes the arm carrier assembly 400 and thereby the contact carrier assembly 500 to rotate about the central axis X-X′. The rotation of the contact carrier assembly 500 causes the electrical contacts 502 associated with the contact carrier assembly 500 to move along the conductive ink 158, thereby changing the resistance of the resistor card element 152. A signal pertaining to the change in the resistance of the resistor card element 152 is sent to a control module (not shown) via the wires. The control module may then determine the level of liquid in the tank based on the changes in the resistance of the resistor card element 152.

The components of the level sensor assembly 100, such as the first housing 102, the second housing 114, the arm carrier assembly 400, and the contact carrier assembly 500 may be made of any metal or non-metal known in the art. In one example, the components of the level sensor assembly 100 may be made of a polymer, such as acetal resins or polyamide resins.

### INDUSTRIAL APPLICABILITY

The level sensor assembly 100 described herein includes the first housing 102 and the second housing 114. The first and second housing 102, 114 are coupled and sealed with each other. All interfaces at the first and second housings 102, 114 are closed with a tight fitting geometry to protect the components present within the interior space against contamination.

The sealing of the first and second housing 102, 114 obstruct and prevent any foreign particles as small as approximately ten microns in size from entering into the interior chamber. Thus, electrical elements associated with the contact carrier assembly 500 and the resistor card element 152 is protected from damage due to the foreign particles present in the liquid. Further, the rotating components of the level sensor assembly 100 such as the arm carrier assembly 400 and the contact carrier assembly 500 have close fit features to block any debris from entering the interior space.

The resistor card element 152 fits tightly in the second housing 114 providing minimal clearance for debris. The first housing 102 further locks the resistor card element 152 into the groove 132 once assembled. Although the design of the level sensor assembly 100 is such that contaminants are prevented from entering the interior chamber and damaging the electrical components present therein, the design allows clean liquid to enter and lubricate the wear prone surfaces of the level sensor assembly 100.

The ceramic card 156 includes vias for allowing soldering of the wires to the resistor card element 152 from an outside of the first and second housing 102, 114. Thus, the first and second housing 102, 114 need not be decoupled for soldering of the wires. Further, the coupling mechanism 600 decouples the electrical contacts 502 from small changes in float position. Moreover, the coupling mechanism 600 provides built-in hysteresis to reduce wear at the interface between the arm carrier assembly 400 and the contact carrier assembly 500 from fuel slosh, thereby extending life of the arm carrier assembly 400 and the contact carrier assembly 500. The level sensor assembly 100 disclosed herein is a reliable fuel level sensing device and does not include any costly components. Further, the level sensor assembly 100 may be easily retrofitted to existing tanks.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A level sensor assembly comprising:
a first housing;
a second housing cooperating with the first housing, wherein the first and second housings are coupled to define an internal chamber therewithin;
an arm carrier assembly coupled to a first surface of the first housing, the arm carrier assembly including a channel provided on a first surface of the arm carrier assembly, the arm carrier assembly further including a through hole, the channel and the through hole arranged in a perpendicular relationship with each other, the channel and the through hole configured to receive a float wire;
a contact carrier assembly having a main body unit extending vertically within the internal chamber, the contact carrier assembly including electrical contacts, wherein the contact carrier assembly is aligned with respect to the arm carrier assembly to receive the float wire;
a coupling mechanism provided at an interface of the arm carrier assembly and the contact carrier assembly, wherein the coupling mechanism is configured to prevent relatively small movements from translating in the level sensor assembly; and
a resistor card element coupled to the second housing, the resistor card element in electrical communication with the contacts of the contact carrier assembly, wherein a resistance associated with the resistor card element is configured to vary based on an angular position of the contact carrier assembly with respect to the resistor card element.
